(19) United States
(12) Patent Application Publication
(10) Pub. No.: US 2023/0137451 A1
(43) Pub. Date: May 4, 2023

(54) HEAVY CRADLE FOR REPLACEABLE CORIOLIS FLOW SENSORS

(71) Applicant: Malema Engineering Corporation, Boca Raton, FL (US)

(72) Inventors: Deepak Bhagwan Malani, Boca Raton, FL (US); Jayasekar Rajagopalan, Boca Raton, FL (US)

(21) Appl. No.: 17/523,185

(22) Filed: Nov. 10, 2021

Related U.S. Application Data
(60) Provisional application No. 63/274,841, filed on Nov. 2, 2021.

(51) Int. Cl. G01F 1/84

(52) U.S. Cl. CPC G01F 1/8409; G01F 1/8472

(57) ABSTRACT

Embodiments relate to a flow process system comprising a cradle and a locking mechanism. The cradle has a mounting structure for a Coriolis flow sensor, and the cradle has significantly more mass than the Coriolis flow sensor. The locking mechanism is used to lock and unlock Coriolis flow sensors in place on the mounting structure. The locking mechanism produces sufficient locking force when locked that the Coriolis flow sensor and cradle vibrate as a unitary body. In this way, the Coriolis flow sensor has effectively more mass when used as part of the flow process system, but Coriolis flow sensors may be easily replaced by unlocking the locking mechanism, removing the current Coriolis flow sensor and replacing it with another.

### CROSS-REFERENCE TO RELATED APPLICATION(S)

This application claims priority under 35 U.S.C. § 119(e) to U.S. Provisional Patent Application Ser. No. 63/274,841, filed Nov. 2, 2021. The subject matter of all of the foregoing is incorporated herein by reference in its entirety.

### BACKGROUND

### 1. Technical Field

This disclosure relates generally to Coriolis flow sensors.

### 2. Description of Related Art

Many applications require the controlled flow of fluids. A flow process system usually includes a number of flow sensors to measure the flow rate of fluids. Coriolis flow sensors measure the flow rate of fluids based on vibrations caused by the Coriolis effect of fluid flowing through the sensor. Cross-talk or destructive interference is a phenomenon where two or more flow sensors may interfere with each other. The cross-talk can include electrical cross-talk, mechanical cross-talk, and/or fluid pulsation based cross-talk. The cross-talk can cause inaccurate measurement by the flow sensors. A flow process system can also include pumps. Operation of the pumps can also interfere with vibration within the flow sensors, which also causes inaccurate measurement by the flow sensors. Vibrations from other devices either external to the flow process system (but in close proximity) or on the flow process system such as solenoid valves, pinch control valves and other electromechanical devices can also cause electrical interference or mechanical interference to the proper functioning of these Coriolis flow sensors

In order to reduce these unwanted effects, a flow sensor may be permanently attached to a large mass. For example, a flow sensor may be welded to a large metal structure. However, these metal masses can be expensive and are not suitable for single use/disposable applications. Also, sterilization of flow sensors having metal enclosures is typically implemented by using chemicals, which is not as effective and can cause malfunction of the flow sensors. Thus, improved technologies for mitigating cross-talk and pump and other external interference are needed.

### SUMMARY

Embodiments relate to a flow process system comprising a cradle and a locking mechanism. The cradle has a mounting structure for a Coriolis flow sensor, and the cradle has significantly more mass than the Coriolis flow sensor. The locking mechanism is used to lock and unlock Coriolis flow sensors in place on the mounting structure. The locking mechanism produces sufficient locking force when locked that the Coriolis flow sensor and cradle vibrate as a unitary body. In this way, the Coriolis flow sensor has effectively more mass when used as part of the flow process system, but Coriolis flow sensors may be easily replaced by unlocking the locking mechanism, removing the current Coriolis flow sensor and replacing it with another. This replacement of sensors after completing a process batch is critical to single use manufacturing of bio-pharmaceuticals and vaccines such as the Covid-19 vaccine.

Other aspects include components, devices, systems, improvements, methods, processes, applications, and other technologies related to any of the above.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1A shows a perspective view of a Coriolis flow sensor and a corresponding cradle.

FIG. 1B shows a cross section view of the Coriolis flow sensor.

FIG. 1C shows a perspective view of the Coriolis flow sensor locked into the cradle.

FIG. 1D shows top, front and side views of the Coriolis flow sensor locked into the cradle.

FIGS. 2A and 2B show top perspective and bottom perspective views of the cradle.

FIG. 3 shows the cradle attached to a skid.

FIGS. 4A and 4B show perspective views of another embodiment of a Coriolis flow sensor and corresponding cradle.

FIGS. 5A and 5B show perspective views of yet another embodiment of a Coriolis flow sensor and corresponding cradle.

FIGS. 6A and 6B show perspective views of yet another embodiment of a Coriolis flow sensor and corresponding cradle.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

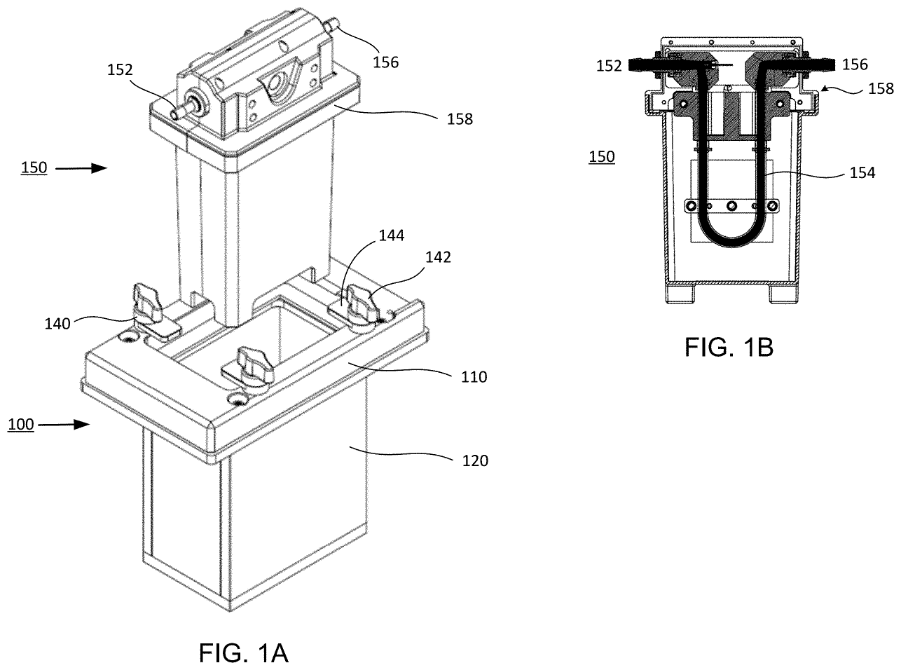

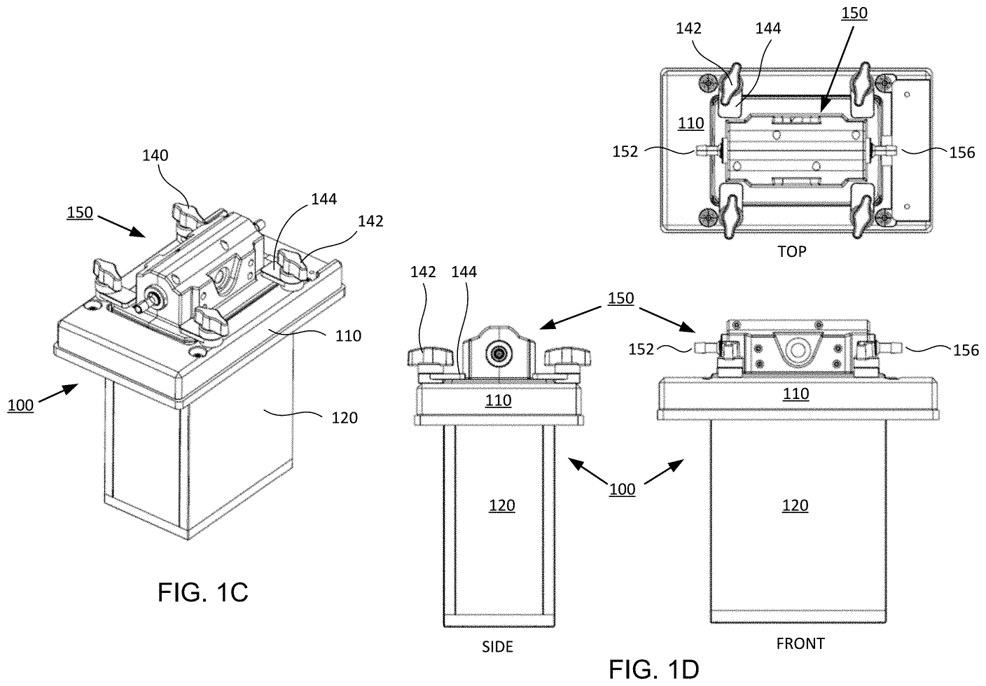

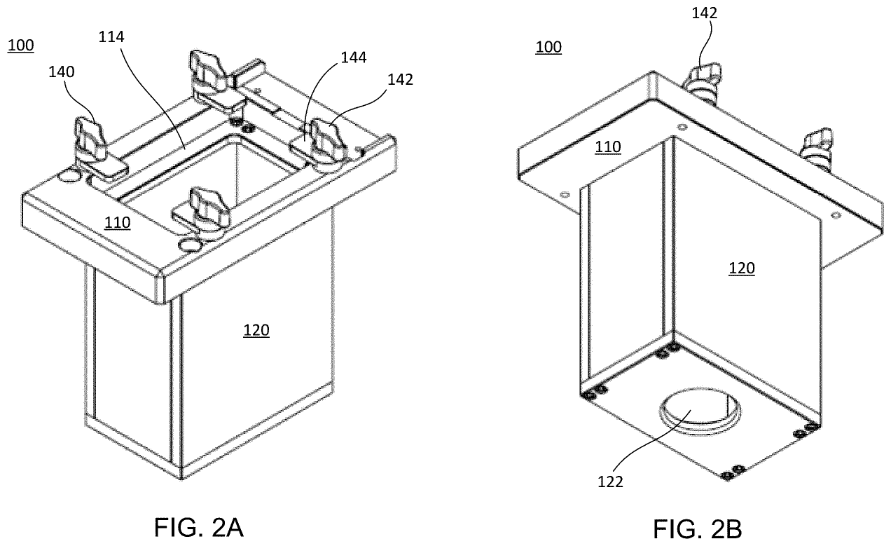

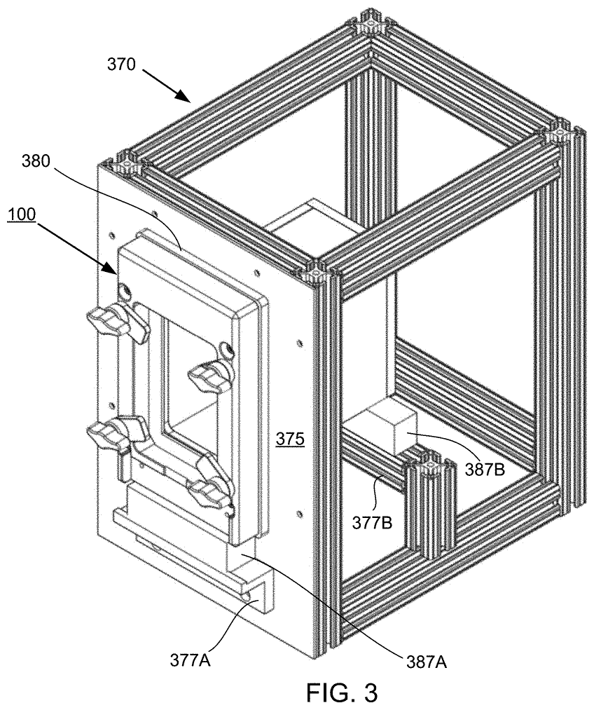

Reference is first made to FIGS. 1-2, which show different views of an example embodiments of a Coriolis flow sensor 150 and corresponding cradle 100. FIG. 1 shows both the Coriolis flow sensor 150 and the cradle 100, where FIG. 1A is an exploded view, FIG. 1B shows just the flow sensor, FIG. 1C shows the assembled system, and FIG. 1D shows top, front and side views of the assembled system. FIG. 2 shows just the cradle 100 and locking mechanism 140, where FIGS. 2A and 2B are perspective views.

The Coriolis flow sensor 150 is a device that measures the flow rate of a fluid based on vibrations caused by the Coriolis effect of the fluid flowing through the sensor. The flow sensor 150 can be seen in cross section in FIG. 1B. The flow sensor 150 includes an inlet 152, a flow tube 154 (or two flow tubes in some designs) and an outlet 156. This provide a flow path for a fluid through the flow sensor 150. The flow tubes 154 can vibrate, for example as driven by magnets and coils. As the fluid flows through the flow tubes 154, Coriolis forces produce a twisting vibration of the flow tubes, resulting in a phase shift in the vibration of the flow tubes. The fluid flow also changes the resonant frequency of the flow tubes. The flow sensor 150 includes transducers that generate electrical signals that are sensitive to the phase shift and/or change in resonant frequency. These signals may be processed to determine the mass fluid flow rate and/or density of the fluid.

The figures show examples of Coriolis flow sensors, but it should be understood that other types of Coriolis flow sensors may also be used. The number and shapes of tubes, the material and construction of the tubes and flow sensor, and the arrangement of the inlet and outlet may all be changed depending on the specific design of the Coriolis flow sensor. Typically, Coriolis flow sensors are sized with connections from 1/16″ to 1″ hose barbs or tri-clamp fittings. Other types of fittings may also be used on Coriolis flow sensors. Typical flow ranges of these flow sensors range from 0.05 gm/min to 0.5 gm/min for the smallest ( 1/16″ hose barb connections) size to 10 kg/min to 100 kg/min for the largest (1″) size. Typical accuracies range from 0.1% to 1.00% of actual reading.

Because Coriolis flow sensors operate based on changes in the vibration of the flow tubes, vibration effects that are caused by sources other than the fluid flow may introduce inaccuracies. For example, if the flow sensor and other devices are mounted on a common support structure, then vibrations from pumps and other devices may mechanically couple to the flow sensor through the supporting structure. The vibration of the flow tubes may also be distorted or otherwise changed through resonant coupling to the surrounding support structure.

Zero drift is one such effect. Coriolis flow sensors are electrically powered on, even when they are not measuring flow. So when there is no flow being pumped or flowing through the Coriolis Flow tubes, the tubes continue to vibrate. Sometimes these tubes are empty and sometimes there is liquid in these tubes. Zero drift is a phenomenon which shows some minimal flow rate occurring when there is no real actual flow. One instance of zero drift is when there is dormant fluid left in the Coriolis flow tubes and a certain amount of sloshing occurs. This minimal flow rate is very small and is usually a very small percentage of the minimum flow rate of each Coriolis flow sensor. In addition, vibrations from external mechanical devices such as pumps and valves also cause zero drift by interfering with the analog or digital output signal from a Coriolis flow sensor by contributing to it.

One way to reduce zero drift is to increase the mass of the flow sensor. More mass dampens out external mechanical vibrating interferences and also the sloshing of dormant liquid will be subdued due to heavier mass.

However, in some applications, the Coriolis flow sensors are not permanent. They are intended to be replaced fairly regularly. They may even be single use or considered to be disposable. Single use or disposable Coriolis flow sensors are used in the bio-pharmaceutical and pharmaceutical industries to manufacture vaccines including vaccines for Covid-19, active pharmaceutical ingredients for cell and gene therapy and nuclear medicine manufacturing. These kinds of single use or disposable Coriolis flow sensors can also be used in specialty fine chemical manufacturing processes where the chemical may corrode away metal Coriolis flow sensors very quickly.

In these cases, it is desirable to make the Coriolis flow sensor as lightweight and inexpensive as possible, so making a large and massive Coriolis flow sensor is not desirable. In addition, some applications may also require the sterilization of flow sensors. Metal is more difficult to sterilize, so making Coriolis flow sensors with metal flow tubes or with large chunks of added metal mass also is not desirable. In these cases, the flow tubes 154 and much of the rest of the Coriolis flow sensor may be made from non-metal materials such as polymer materials, including Polyetheretherketone (PEEK), Perfluoroalkoxy polymers (PFAs), polyvinylidene difluoride (PVDF), Polytetrafluoroethylene (PTFE), and Fluorinated ethylene propylene (FEP). For further examples, see U.S. patent application Ser. No. 16/837,635 “Polymer-Based Coriolis Mass Flow Sensor Fabricated Through Casting,” which is incorporated by reference in its entirety. Gamma irradiation may be used to sterilize the flow sensor, in which case the flow sensor is constructed from materials that are gamma irradiatable, for example up to a minimum of 50 kGy which may be the irradiation levels used for sterilization in certain bio-pharma applications.

In the examples shown herein, the effective mass of the Coriolis flow sensor 150 is increased by locking it to a heavy cradle 100 when it is in use. The cradle 100 has a mass that preferably is at least 10 to 30 times the mass of the Coriolis flow sensor. For example, typical Coriolis flow sensors may have masses in the range of 0.2 kg˜3 kg and typical mass for the heavy cradle may then be 5 kg˜80 kg.

The cradle 100 has a mounting structure 114 (see FIG. 2A) for the Coriolis flow sensor 100, and a locking mechanism 140 is used to lock and unlock the Coriolis flow sensor in place on the mounting structure. The locking mechanism produces sufficient locking force when locked that the Coriolis flow sensor 150 and cradle 100 (as shown in FIG. 1A) vibrate together as a unitary body.

In the example of FIGS. 1-2, the cradle 100 includes a rectangular metal collar 110 which accounts for a significant amount of the mass of the cradle. The collar 110 has a rectangular aperture with an interior lip 114, which is most visible in FIG. 2. The lip is also rectangular and annular in shape. The flow sensor 150 includes a plastic housing with a ridge 158. The ridge 158 fits into the aperture of the metal collar 110 and presses against the lip 114. The locking mechanism 140 applies force to the ridge 158 to hold the ridge rigidly against the lip 114. The flow tubes 154 protrude through the annular opening in the lip 114.

In this example, the locking mechanism 140 uses thumb screws 142 to create the force. When tightened, the thumb screws 142 apply pressure to tongues 144, which in turn press the ridge 158 against the interior lip 114 of the metal collar 110. The thumb screws are designed to apply a specific amount of force. In the example shown, the force is applied at four locking points arranged in a rectangular shape, although other arrangements are also possible. The applied force should be large enough to adequately reduce vibration of the flow sensor 150 relative to the collar 110. As a result, the flow sensor 150 and cradle 100 will vibrate as a unitary body and the cradle 100 will effectively increase the mass of the flow sensor 150, rather than the two vibrating relative to each other. For example, each of the thumb screws 142 may apply 3 Newton-meters (Nm) of force or more, to hold the flow sensor 150 and cradle 100 rigidly relative to each other. This is an aggregate force of 12 Nm or more for all of the thumb screws. In other designs, lower locking forces may be acceptable, for example 10 Nm or more, or 5 Nm or more.

Applying uniform force is also important. Applying the same force at the four locking points allows for the pressure to be balanced. If the forces at the different locking points were not the same, the sensor would be imbalanced and the zero drift and resulting inaccuracy would be higher. In FIGS. 1-2, the same amount of force should be applied to each locking point. For example, the force applied at each of the locking points may be within 15% of each other, or more preferably within 10%, within 5% or even within 1% of each other.

One advantage of using thumb screws 142 is that the locking mechanism may be operated manually. The thumb screws 142 may be loosened, the tongues 144 rotated or swiveled away to release the flow sensor 150, and the flow sensor removed and replaced with another flow sensor. This facilitates the replacement of flow sensors, including disposable and single use flow sensors. In some single use or disposable applications, the flow sensors may be removed and replaced in one minute or less.

The cradle 100 also includes enclosure 120, which encloses the rest of the Coriolis flow sensor. The enclosure also adds mass. The enclosure shown in FIGS. 1-2 includes a cable hole 122 (see FIG. 2B) to allow power and data connections to the flow sensor.

FIG. 3 shows the cradle 100 attached to a skid 370. A skid is a mechanical framework on which equipment may be mounted. In this example, the cradle 100 is attached to a metal plate or panel 375, which is attached to the skid 370. A vibration dampening gasket 380 is positioned between the cradle 100 and the plate 375. In the vertical direction, the cradle 100 is supported by cross members 377A (an L bracket) and 377B (a cross beam of the skid). Vibration dampening gaskets 387A and 387B are positioned between the cradle 100 and the cross members 377A and 377B.

Note that the heavy cradle 100 does not make direct contact with any part of the skid 370. It is always separated by vibration gaskets 380, 387. The gaskets 380, 387 provide vibration isolation between the cradle 100 and the skid 370 (and other components mounted on the skid). For example, the vibration gaskets may significantly dampen low frequency vibrations.

The heavy cradle 100 adds mass to the Coriolis flow sensor 150, and the vibration gaskets 380, 387 isolate the cradle and flow sensor from the rest of the flow process system. As a result, zero drift is reduced. For example, for smaller size sensors (e.g., tubing of ½ inch and less), zero drift was reduced from 100 g/min to 2.5 g/min. Typical minimum flow rate for these sensors is 500 g/min, so the zero drift is reduced to less than 1% of the minimum flow rate. For larger sensors (e.g., ¾ and 1 inch tubing), zero drift was reduced from 200 g/min to 25 g/min. A typical minimum flow rate for these sensors is 6 kg/min, so the zero drift is reduced to less than 1% of the minimum flow rate.

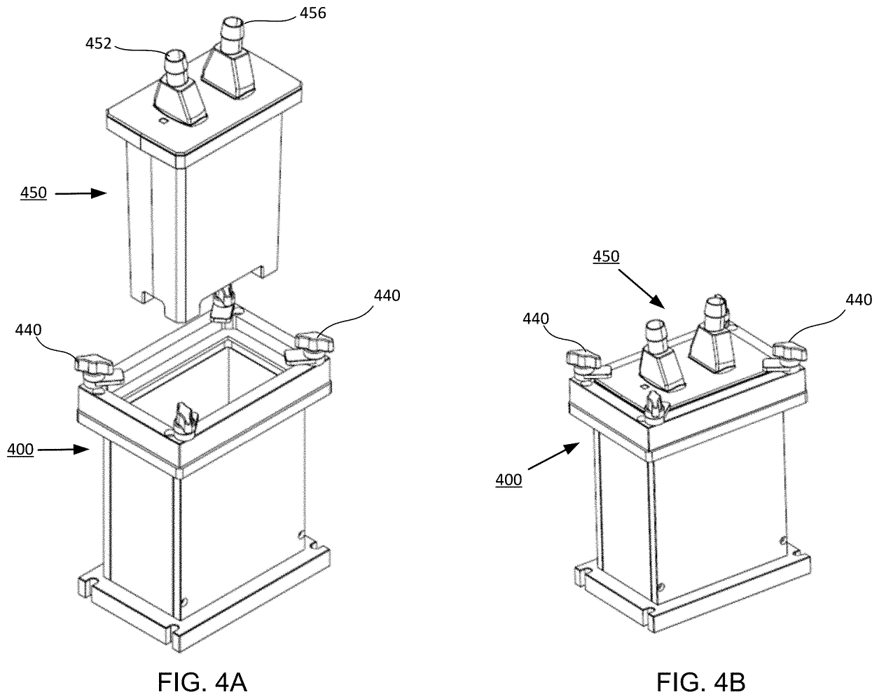

FIGS. 1-3 show one example. Other variations will be apparent. FIGS. 4-6 show perspective views of additional embodiments of a Coriolis flow sensor 450, 550, 650 and corresponding cradle 400, 500, 600. In FIG. 4, the flow sensor 450 has a vertical configuration, whereas the flow sensors in previous figures are in-line configurations. In an in-line configuration (see FIG. 1), the inlet 152 and outlet 156 are in line with each other, but the flow typically is diverted in order to flow through the flow tubes. In a vertical configuration of FIG. 4, the inlet 452 and outlet 456 are not aligned with each other, but the flow is more in line with the flow tubes. The cradle and mounting structure may be designed to accommodate multiple different flow sensors, including both in-line Coriolis flow sensors and vertical Coriolis flow sensors. In addition, in FIG. 4, the locking points 440 are on the corners rather than along the sides.

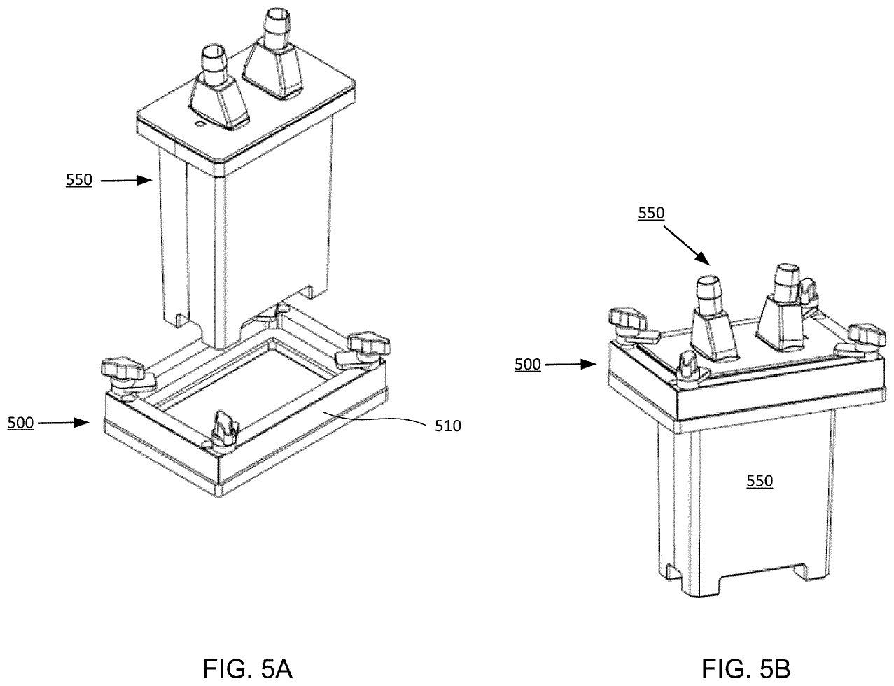

In FIG. 5, the cradle 500 includes the collar 510 but does not have an enclosure. The flow sensor 550 protrudes through the collar 510 and is visible below the collar, as shown in FIG. 5B.

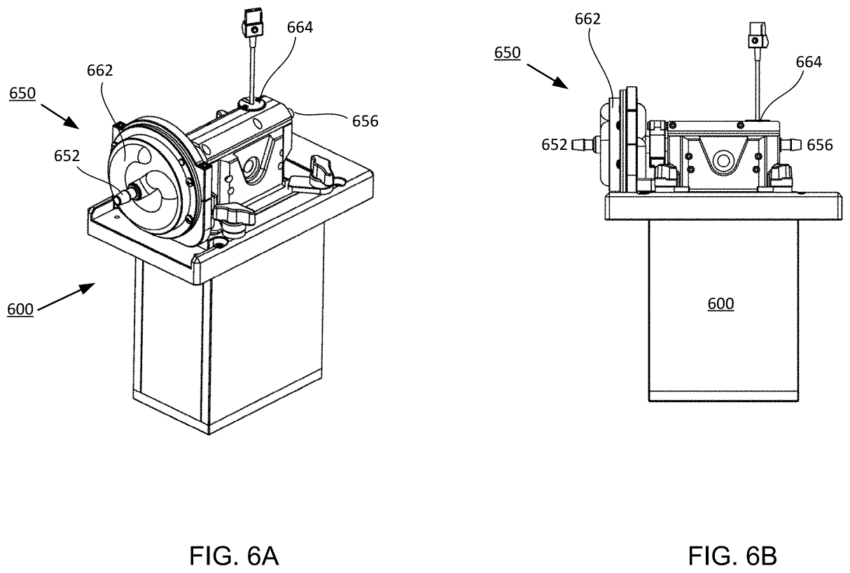

In FIG. 6, the Coriolis flow sensor has an in-line configuration with inlet 652 and outlet 656. It also includes an integrated dampener 662 and integrated pressure sensor 664. The dampener 662 is located on the inlet side of the flow sensor. The integrated dampener reduces vibrations in the fluid flow itself, for example as may be caused by a pulsating pump. Example dampeners are described in U.S. patent application Ser. No. 16/994,611 “Flow Dampener in Flow Measurement System,” which is incorporated by reference in its entirety. Integrating the dampener and pressure sensor reduces the overall size and space requirement, compared to free-standing dampeners and pressure sensors that are connected to tubing on the inlet or outlet. It also reduces the amount of tubing required, which in turn reduces the amount of dead volume. Dead volume is the volume of fluid contained in tubing, sensors and other components, as this volume is lost and not converted to usable product when the system is flushed between batches. Reducing dead volume is important in pharmaceutical manufacturing, because dead volume is wasted product, which can be very valuable. The integrated pressure sensor can also produce more accurate pressure readings for calibrating the Coriolis flow sensor, since it is measuring pressure closer to the actual flow tubes.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. A flow process system comprising:
a cradle having a mounting structure for a Coriolis flow sensor, wherein the cradle has a mass of at least ten (10) times a mass of the Coriolis flow sensor;
a locking mechanism to lock and unlock Coriolis flow sensors in place on the mounting structure, wherein the locking mechanism produces sufficient locking force when locked that the Coriolis flow sensor and cradle vibrate as a unitary body.

2. The flow process system of claim 1 wherein the cradle has a mass of at least 5 kg.

3. The flow process system of claim 1 wherein the cradle and mounting structure are both shaped to accommodate both in-line Coriolis flow sensors and vertical Coriolis flow sensors.

4. The flow process system of claim 1 wherein:
the cradle comprises a rectangular collar that includes most of the mass of the cradle; and
the mounting structure comprises a rectangular annular lip against which the Coriolis flow sensor is mounted, the locking mechanism applying force to the Coriolis flow sensor against the lip.

5. The flow process system of claim 1 wherein the cradle comprises an enclosure that encloses the Coriolis flow sensor.

6. The flow process system of claim 1 wherein the locking mechanism comprises thumb screws.

7. The flow process system of claim 1 wherein the locking mechanism is manually operable to remove and replace the Coriolis flow sensor in one minute or less.

8. The flow process system of claim 1 wherein the locking mechanism applies at least 5 Nm force to lock Coriolis flow sensors in place on the mounting structure.

9. The flow process system of claim 1 wherein the locking mechanism provides a plurality of locking points that apply force to lock Coriolis flow sensors in place on the mounting structure, and the force applied at each of the locking points is within 15% of each other.

10. The flow process system of claim 1 wherein the locking mechanism applies force at four locking points arranged in a rectangular shape to lock Coriolis flow sensors in place on the mounting structure.

11. A flow process system comprising:
a skid for supporting equipment used in an environment that includes a flow of fluid;
a Coriolis flow sensor for measuring a flow rate of fluid flow;
a cradle attached to the skid, the cradle having a mounting structure for the Coriolis flow sensor, wherein the cradle has a mass of at least ten (10) times a mass of the Coriolis flow sensor;
a locking mechanism that locks the Coriolis flow sensor in place on the mounting structure, wherein the locking mechanism produces sufficient locking force that the Coriolis flow sensor and cradle vibrate as a unitary body but the locking mechanism is also unlockable to release the Coriolis flow sensor.

12. The flow process system of claim 11 wherein the Coriolis flow sensor is disposable and/or single-use.

13. The flow process system of claim 11 wherein the Coriolis flow sensor includes polymer flow tubes and is gamma irradiatable to at least 50 kGy.

14. The flow process system of claim 11 wherein the Coriolis flow sensor comprises an integrated dampener.

15. The flow process system of claim 11 wherein the Coriolis flow sensor comprises an integrated pressure sensor.

16. The flow process system of claim 11 further comprising:
gaskets between the cradle and the skid, the gaskets providing vibration dampening between the cradle and the skid.

17. The flow process system of claim 11 wherein the Coriolis flow sensor has a zero drift of not more than 2.5 g/min.

18. The flow process system of claim 11 wherein the Coriolis flow sensor has a zero drift of not more than 1% of a minimum flow rate measured by the Coriolis flow sensor.

19. A flow process system comprising:
a cradle comprising a rectangular metal collar and a rectangular annular lip against which a replaceable Coriolis flow sensor is mounted; wherein the cradle has a mass of at least ten (10) times a mass of the Coriolis flow sensor and the rectangular metal collar includes most of the mass of the cradle;
a plurality of manually operable thumb screws to lock and unlock the Coriolis flow sensor in place against the annular lip, wherein the thumb screws in aggregate apply at least 5 Nm of force to the Coriolis flow sensor against the lip and the force applied by each thumb screw is within 15% of each other; and
gaskets between the cradle and a support for the cradle, the gaskets providing vibration dampening between the cradle and the support.

20. The flow process system of claim 19 wherein the Coriolis flow sensor has a zero drift of not more than 1% of a minimum flow rate measured by the Coriolis flow sensor.
